(19) United States
(12) Patent Application Publication
(10) Pub. No.: US 2026/0037355 A1
(43) Pub. Date: Feb. 5, 2026

(54) Controlling Error Reporting for Usage-Based-Disturbance Mitigation

(71) Applicant: Micron Technology, Inc., Boise, ID (US)

(72) Inventors: Victor Wong, Boise, ID (US); Dennis G. Montierth, Meridian, ID (US); Yang Lu, Boise, ID (US); Donald Morgan, Meridian, ID (US)

(73) Assignee: Micron Technology, Inc., Boise, ID (US)

(21) Appl. No.: 19/276,405

(22) Filed: Jul. 22, 2025

Related U.S. Application Data
(60) Provisional application No. 63/677,809, filed on Jul. 31, 2024.

(51) Int. Cl. G06F 11/07

(52) U.S. Cl. CPC G06F 11/0766; G06F 11/076

(57) ABSTRACT

Apparatuses and techniques for controlling error reporting for usage-based-disturbance mitigation are described. In an example aspect, an adaptable method of controlling error reporting is provided so as to account for an uncertainty regarding a level of intermittent faults associated with a memory device. An error-reporting control circuit provides a mechanism to control how often errors are reported to a host device. In particular, the error-reporting control circuit can filter unnecessary noise associated with intermittent faults based on a parameter that is settable (e.g., programmable or changeable). In this manner, the error-reporting control circuit can provide further confidence at the host device that reported errors are associated with permanent defects. Furthermore, the parameter can be appropriately set for the given memory device based on its design and/or architecture once silicon data is available.

### CROSS-REFERENCE TO RELATED APPLICATION(S)

This application claims the benefit of U.S. Provisional Patent Application Ser. No. 63/677,809 filed on Jul. 31, 2024, the disclosure of which is incorporated by reference herein in its entirety.

### BACKGROUND

Computers, smartphones, and other electronic devices rely on processors and memories. A processor executes code based on data to run applications and provide features to a user. The processor obtains the code and the data from a memory. The memory in an electronic device can include volatile memory (e.g., random-access memory (RAM)) and non-volatile memory (e.g., flash memory). Like the capabilities of a processor, the capabilities of a memory can impact the performance of an electronic device. This performance impact can increase as processors are developed that execute code faster and as applications operate on increasingly larger data sets that require ever-larger memories.

### BRIEF DESCRIPTION OF THE DRAWINGS

Apparatuses of and techniques for controlling error reporting for usage-based-disturbance mitigation are described with reference to the following drawings. The same numbers are used throughout the drawings to reference like features and components:

FIG. 1 illustrates example apparatuses that can implement aspects of controlling error reporting for usage-based-disturbance mitigation;

FIG. 2 illustrates an example computing system that can implement aspects of controlling error reporting for usage-based-disturbance mitigation;

FIG. 3 illustrates example data stored within rows of a memory array;

FIG. 4 illustrates an example memory device in which aspects of controlling error reporting for usage-based-disturbance mitigation can be implemented;

FIG. 5 illustrates an example arrangement of circuits that can implement aspects of controlling error reporting for usage-based-disturbance mitigation;

FIG. 6 illustrates an example implementation of a memory device capable of controlling error reporting for usage-based-disturbance mitigation;

FIG. 7 illustrates example implementations of an error-reporting control circuit and an alert circuit;

FIG. 8 illustrates an example scheme performed by an error-reporting control circuit for controlling error reporting for usage-based-disturbance mitigation;

FIG. 9 illustrates a first example method for implementing aspects of controlling error reporting for usage-based-disturbance mitigation; and

FIG. 10 illustrates a second example method for implementing aspects of controlling error reporting for usage-based-disturbance mitigation.

### DETAILED DESCRIPTION

### Overview

Processors and memory work in tandem to provide features to users of computers and other electronic devices. As processors and memory operate more quickly together in a complementary manner, an electronic device can provide enhanced features, such as high-resolution graphics and artificial intelligence (AI) analysis. Some applications, such as those for financial services, medical devices, and advanced driver assistance systems (ADAS), can also demand more-reliable memories. These applications use increasingly reliable memories to limit errors in financial transactions, medical decisions, and object identification. However, in some implementations, more-reliable memories can sacrifice bit densities, power efficiency, and simplicity.

To meet the demands for physically smaller memories, memory devices can be designed with higher chip densities. Increasing chip density, however, can increase the electromagnetic coupling (e.g., capacitive coupling) between adjacent or proximate rows of memory cells due, at least in part, to a shrinking distance between these rows. With this undesired coupling, activation (or charging) of a first row of memory cells can sometimes negatively impact a second nearby row of memory cells. In particular, activation of the first row can generate interference, or crosstalk, that causes the second row to experience a voltage fluctuation. In some instances, this voltage fluctuation can cause a state (or value) of a memory cell in the second row to be incorrectly determined by a sense amplifier. Consider an example in which a state of a memory cell in the second row is a “1.” In this example, the voltage fluctuation can cause a sense amplifier to incorrectly determine the state of the memory cell to be a “0” instead of a “1.” Left unchecked, this interference can lead to memory errors or data loss within the memory device.

In some circumstances, a particular row of memory cells is activated repeatedly in an unintentional or intentional (sometimes malicious) manner. Consider, for instance, that memory cells in an R^{th} row are subjected to repeated activation, which causes one or more memory cells in a proximate row (e.g., within an R+1 row, an R+2 row, an R−1 row, and/or an R−2 row) to change states. This effect is referred to as usage-based disturbance. The occurrence of usage-based disturbance can lead to the corruption or changing of contents within the affected row of memory.

Some memory devices utilize circuits that can detect usage-based disturbance and mitigate its effects. To monitor for usage-based disturbance, a memory device can store an activation count for each row of a memory array. The activation count keeps track of a quantity of accesses or activations of the corresponding memory row. If the activation count meets (e.g., equals or exceeds) a threshold, nearby rows may be at increased risk for data corruption due to the repeated activations of the accessed row and the usage-based disturbance effect. To manage this risk to the affected rows, the memory device can refresh the proximate rows.

The effectiveness of this protective feature is jeopardized, however, if the memory cells that store the activation count fail or become permanently faulty. To address this problem, some memory devices can detect the faulty memory cells and report these to a host device. The host device can initiate a repair process that replaces a faulty memory cell in a permanent (or “hard”) manner or in a temporary (or “soft”) manner.

The repair process, however, takes time and can cause the memory device to be temporarily unavailable for performing other operations (e.g., normal read and/or write operations). It is therefore important to be accurate in reporting failures so that normal operations are not interrupted or delayed by performing unnecessary repair operations. There is also a limited quantity of replacement cells, so such replacement cells should not be used on cells that are not permanently faulty. It can be challenging to abide by these factors because some memory cells can be intermittently faulty. These intermittent faults can also be challenging to estimate without additional testing and data. Furthermore, as memory devices are implemented with different processes and different architectures, the defective parts-per-million estimate is subject to change. There is therefore a general need to report faults of a permanent nature while safeguarding against reporting faults of an intermittent nature.

To address this and other issues regarding usage-based disturbance, this document describes techniques for controlling error reporting for usage-based-disturbance mitigation. In an example aspect, an adaptable method of controlling error reporting is provided so as to account for an uncertainty regarding a level of intermittent faults associated with a memory device. An error-reporting control circuit provides a mechanism to control how often errors are reported to a host device. In particular, the error-reporting control circuit can filter unnecessary noise associated with intermittent faults based on a parameter that is settable (e.g., programmable or changeable). In these manners, the error-reporting control circuit can provide further confidence at the host device that reported errors are associated with permanent defects. Furthermore, the parameter can be appropriately set for the given memory device based on its design and/or architecture once silicon data is available or based on one or more other factors, such as a given deployment's tolerance for downtime or susceptibility to usage-based disturbances.

### Example Operating Environments

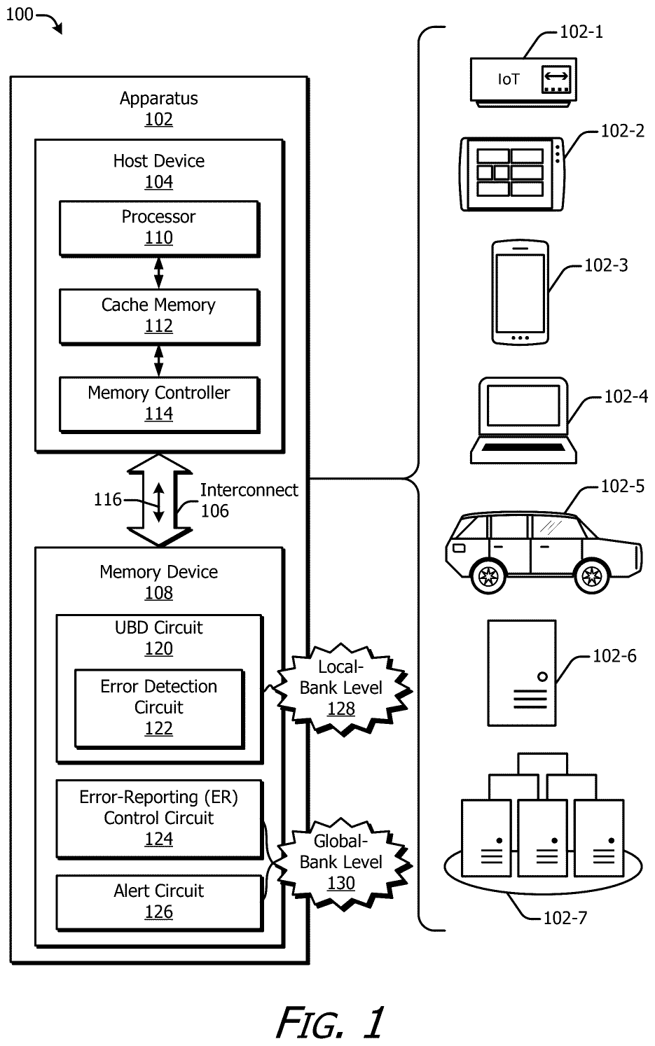

FIG. 1 illustrates, at 100 generally, an example operating environment including an apparatus 102 that can control error reporting for usage-based-disturbance mitigation. The apparatus 102 can include various types of electronic devices, including an internet-of-things (IoT) device 102-1, tablet device 102-2, smartphone 102-3, notebook computer 102-4, passenger vehicle 102-5, server computer 102-6, and server cluster 102-7 that may be part of cloud computing infrastructure, a data center, or a portion thereof (e.g., a printed circuit board (PCB)). Other examples of the apparatus 102 include a wearable device (e.g., a smartwatch or intelligent glasses), entertainment device (e.g., a set-top box, video dongle, smart television, a gaming device), desktop computer, motherboard, server blade, consumer appliance, vehicle, drone, industrial equipment, security device, sensor, or the electronic components thereof. Each type of apparatus can include one or more components to provide computing functionalities or features.

In example implementations, the apparatus 102 can include at least one host device 104, at least one interconnect 106, and at least one memory device 108. The host device 104 can include at least one processor 110, at least one cache memory 112, and a memory controller 114. The memory device 108, which can also be realized with a memory module, can include, for example, a dynamic random-access memory (DRAM) die or module (e.g., Low-Power Double Data Rate synchronous DRAM (LPDDR SDRAM)). The DRAM die or module can include a three-dimensional (3D) stacked DRAM device, which may be a high-bandwidth memory (HBM) device or a hybrid memory cube (HMC) device. The memory device 108 can operate as a main memory for the apparatus 102. Although not illustrated, the apparatus 102 can also include storage memory. The storage memory can include, for example, a storage-class memory device (e.g., a flash memory, hard disk drive, solid-state drive, phase-change memory (PCM), or memory employing 3D XPoint™).

The processor 110 is operatively coupled to the cache memory 112, which is operatively coupled to the memory controller 114. The processor 110 is also coupled, directly or indirectly, to the memory controller 114. The host device 104 may include other components to form, for instance, a system-on-a-chip (SoC). The processor 110 may include a general-purpose processor, central processing unit, graphics processing unit (GPU), neural network engine or accelerator, application-specific integrated circuit (ASIC), field-programmable gate array (FPGA) integrated circuit (IC), or communications processor (e.g., a modem or baseband processor).

In operation, the memory controller 114 can provide a high-level or logical interface between the processor 110 and at least one memory (e.g., an external memory). The memory controller 114 may be realized with any of a variety of suitable memory controllers (e.g., a double-data-rate (DDR) memory controller that can process requests for data stored on the memory device 108). Although not shown, the host device 104 may include a physical interface (PHY) that transfers data between the memory controller 114 and the memory device 108 through the interconnect 106. For example, the physical interface may be an interface that is compatible with a DDR PHY Interface (DFI) Group interface protocol. The memory controller 114 can, for example, receive memory requests from the processor 110 and provide the memory requests to external memory with appropriate formatting, timing, and reordering. The memory controller 114 can also forward to the processor 110 responses to the memory requests received from external memory.

The host device 104 is operatively coupled, via the interconnect 106, to the memory device 108. In some examples, the memory device 108 is connected to the host device 104 via the interconnect 106 with an intervening buffer or cache. The memory device 108 may operatively couple to storage memory (not shown). The host device 104 can also be coupled, directly or indirectly via the interconnect 106, to the memory device 108 and the storage memory. The interconnect 106 and other interconnects (not illustrated in FIG. 1) can transfer data between two or more components of the apparatus 102. Examples of the interconnect 106 include a bus (e.g., a unidirectional or bidirectional bus), switching fabric, or one or more wires that carry voltage or current signals. The interconnect 106 can propagate one or more communications 116 between the host device 104 and the memory device 108. For example, the host device 104 may transmit a memory request to the memory device 108 over the interconnect 106. Also, the memory device 108 may transmit a corresponding memory response to the host device 104 over the interconnect 106.

The illustrated components of the apparatus 102 represent an example architecture with a hierarchical memory system. A hierarchical memory system may include memories at different levels, with each level having memory with a different speed or capacity. As illustrated, the cache memory 112 logically couples the processor 110 to the memory device 108. In the illustrated implementation, the cache memory 112 is at a higher level than the memory device 108. A storage memory, in turn, can be at a lower level than the main memory (e.g., the memory device 108). Memory at lower hierarchical levels may have a decreased speed but increased capacity relative to memory at higher hierarchical levels.

The apparatus 102 can be implemented in various manners with more, fewer, or different components. For example, the host device 104 may include multiple cache memories (e.g., including multiple levels of cache memory) or no cache memory. In other implementations, the host device 104 may omit the processor 110 or the memory controller 114. A memory (e.g., the memory device 108) may have an “internal” or “local” cache memory. As another example, the apparatus 102 may include cache memory between the interconnect 106 and the memory device 108. Computer engineers can also include any of the illustrated components in distributed or shared memory systems.

Computer engineers may implement the host device 104 and the various memories in multiple manners. In some cases, the host device 104 and the memory device 108 can be disposed on, or physically supported by, a printed circuit board (e.g., a rigid or flexible motherboard). The host device 104 and the memory device 108 may additionally be integrated together on an integrated circuit or fabricated on separate integrated circuits and packaged together. The memory device 108 may also be coupled to multiple host devices 104 via one or more interconnects 106 and may respond to memory requests from two or more host devices 104. Each host device 104 may include a respective memory controller 114, or the multiple host devices 104 may share a memory controller 114. This document describes with reference to FIG. 1 an example computing system architecture having at least one host device 104 coupled to a memory device 108.

Two or more memory components (e.g., modules, dies, banks, or bank groups) can share the electrical paths or couplings of the interconnect 106. The interconnect 106 can include at least one command-and-address bus (CA bus) and at least one data bus (DQ bus). The command-and-address bus can transmit addresses and commands from the memory controller 114 of the host device 104 to the memory device 108, which may exclude propagation of data. The data bus can propagate data between the memory controller 114 and the memory device 108. The memory device 108 may also be implemented as any suitable memory including, but not limited to, DRAM, SDRAM, three-dimensional (3D) stacked DRAM, DDR memory, or LPDDR memory (e.g., LPDDR DRAM or LPDDR SDRAM).

The memory device 108 can form at least part of the main memory of the apparatus 102. The memory device 108 may, however, form at least part of a cache memory, a storage memory, or a system-on-chip of the apparatus 102. The memory device 108 includes at least one usage-based-disturbance circuit 120 (UBD circuit 120). The usage-based-disturbance circuit 120 mitigates usage-based disturbance for one or more banks associated with the memory device 108. This includes detecting a condition associated with usage-based disturbance and initiating a refresh of one or more victim rows associated with the detected condition.

The usage-based-disturbance circuit 120 includes at least one error detection circuit 122. The error detection circuit 122 detects an occurrence (or absence) of an error (or fault) associated with data that is referenced by the usage-based disturbance circuit 120 to monitor for usage-based disturbance. The error detection circuit 122 can be integrated within the usage-based-disturbance circuit 120 or can be considered separate from the usage-based-disturbance circuit 120.

Generally speaking, the error detection circuit 122 can perform a variety of error detection tests to determine whether or not the usage-based-disturbance data (or memory cells that store the usage-based-disturbance data) is faulty or defective. In a first example implementation, the error detection circuit 122 detects a parity error associated with the usage-based-disturbance data. Other example implementations of the error detection circuit 122 can perform an error-correcting-code check, a checksum check, a cyclic redundancy check, another type of error detection procedure, or some combination thereof. The type of test and/or the utilization of multiple tests can be chosen such that the memory device 108 can realize a particular level of reliability in reporting faulty memory cells that store the usage-based-disturbance data.

The memory device 108 also includes at least one error-reporting control circuit 124 and at least one alert circuit 126. The usage-based-disturbance circuit 120, the error-reporting control circuit 124, and the alert circuit 126 can each be implemented using software, firmware, hardware, fixed logic circuitry, or some combinations thereof.

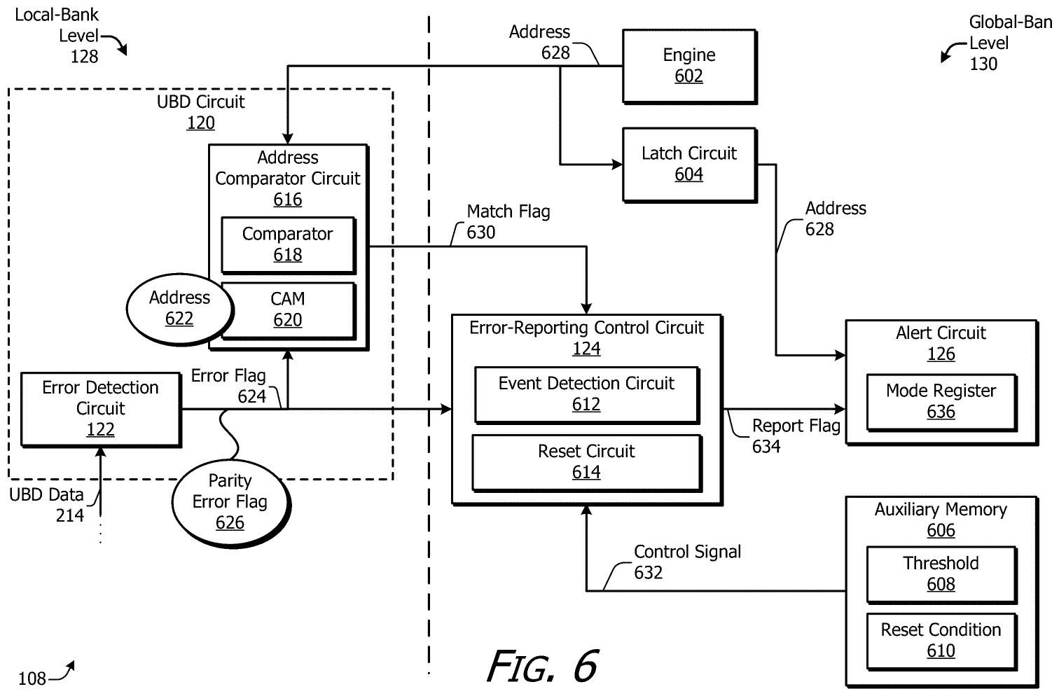

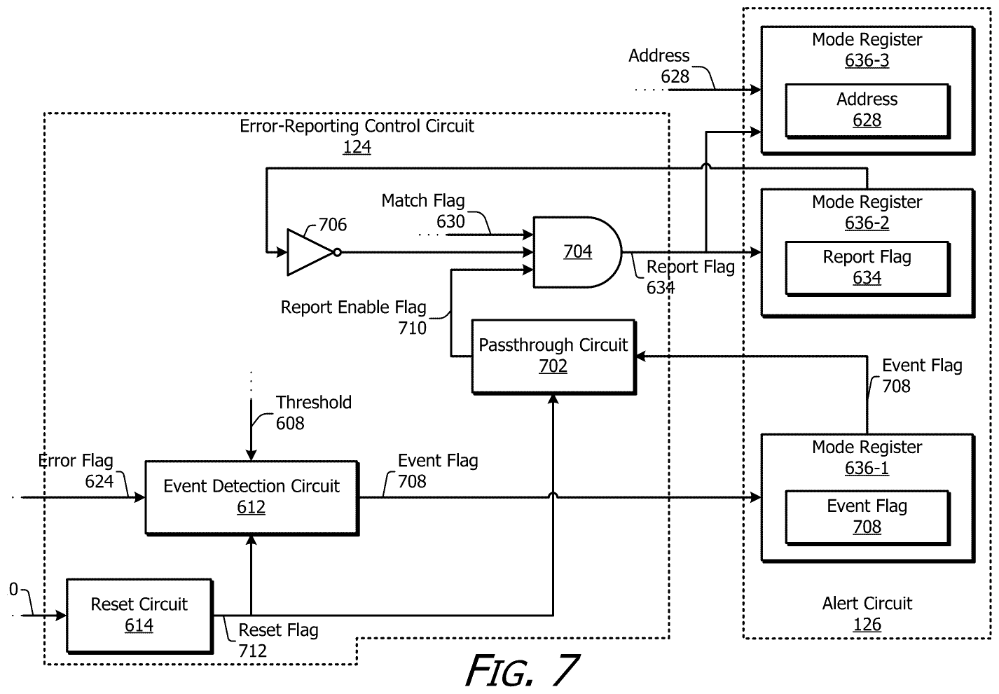

The error-reporting control circuit 124 manages reporting of an error to the host device 104 via the alert circuit 126. In one aspect, the error-reporting control circuit 124 provides an adaptable means for controlling error reporting. This enables the error reporting to be appropriately set based on a design and/or an architecture of the memory device 108 once silicon data is available. It also enables unnecessary noise associated with intermittent faults to be filtered. This can be particularly useful during situations in which the silicon data is unavailable. Example implementations of the error-reporting control circuit 124 are further described with respect to FIGS. 6 and 7.

The alert circuit 126 enables information about the error and an address associated with the error to be communicated to or accessed by the host device 104 (e.g., the memory controller 114). In general, the alert circuit 126 provides a means for communicating an error detected by the memory device 108 to the host device 104. The alert circuit 126 can be implemented using one or more mode registers, as further described with respect to FIGS. 6 and 7.

With the information provided by the alert circuit 126, the host device 104 can initiate a repair procedure to fix the faulty data within the memory device 108. One type of repair procedure is a hard post-package repair (hPPR) procedure. For the hard post-package repair procedure, the memory controller 114 can request that the memory device 108 permanently repair a whole combination row, including the faulty data used for usage-based disturbance mitigation. With this repair procedure, however, the viability of existing data stored in the memory row is uncertain. Further, the permanent, nonvolatile nature of the hard post-package repair can entail blowing a fuse. The procedure is relatively lengthy and can often be performed only during power up and initialization, or with a full memory reset, instead of in real-time while the memory device 108 is functional and performing memory operations for the host device 104.

In contrast with the hard post-package repair, a soft post-package repair (sPPR) is a temporary repair procedure that is significantly faster. Further, although a soft post-package repair procedure produces a volatile repair, the soft post-package repair procedure can be performed in real-time responsive to detection of a failure. If a memory row is being repaired, the computing system may be responsible, however, for handling the data transfer (e.g., a full page of data) from the memory row corresponding to the faulty data to a spare counter and memory row combination. This data transfer can consume an appreciable amount of time while occupying the data bus.

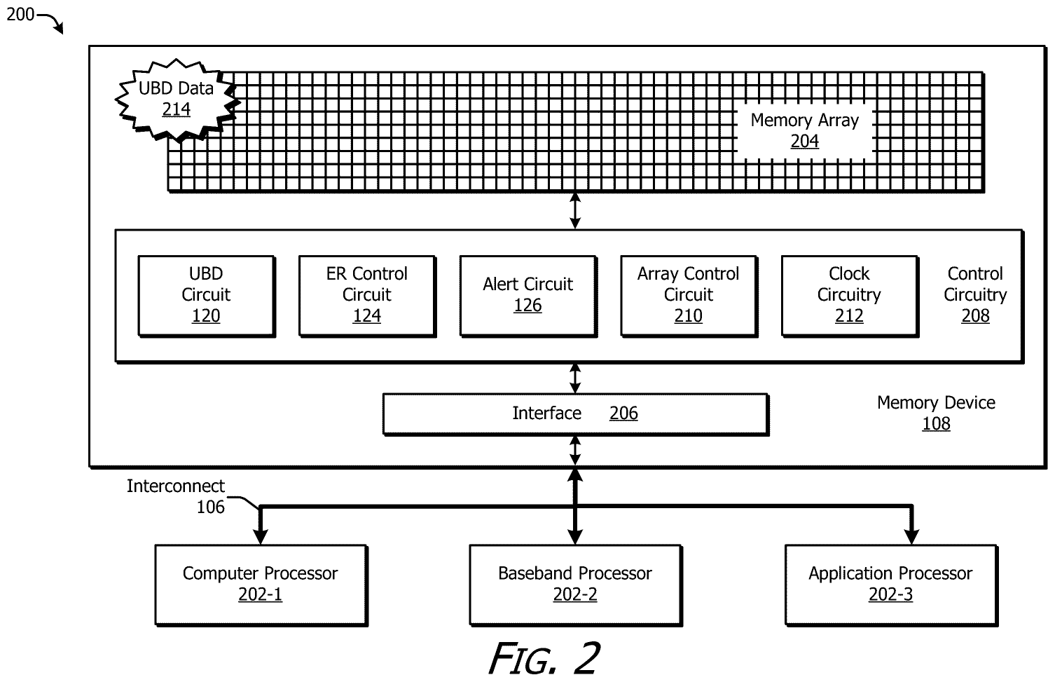

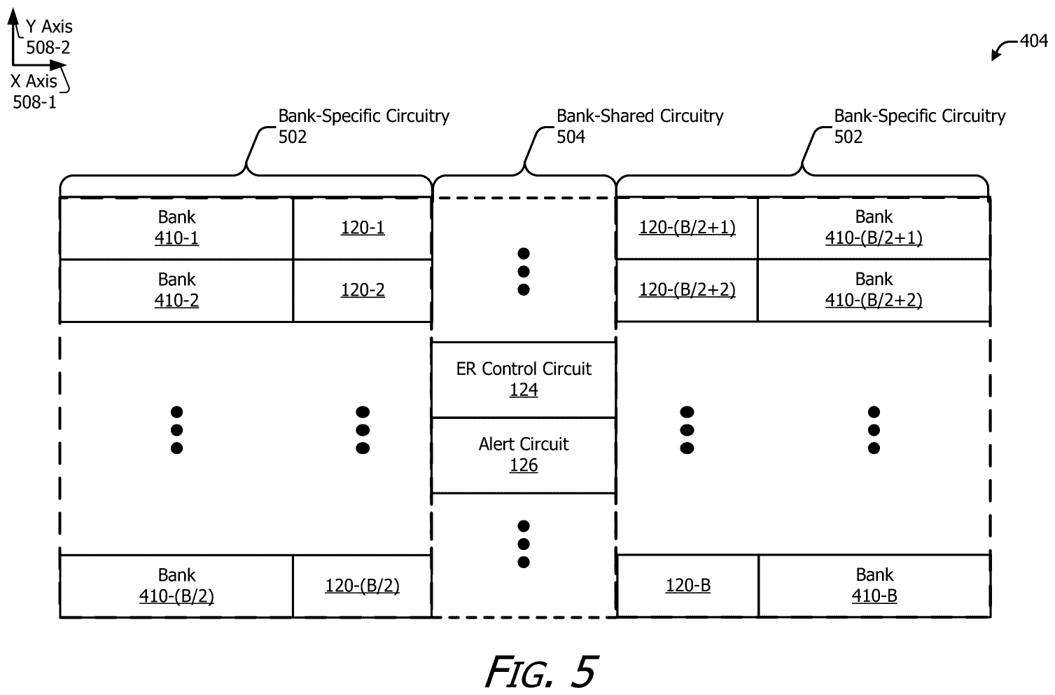

In example implementations, the usage-based-disturbance circuit 120 is implemented at a local-bank level 128 (or a local level). This means that each instance of the usage-based-disturbance circuit 120 is associated with a particular bank or a particular set of banks. In contrast, the error-reporting control circuit 124 and the alert circuit 126 are implemented at a global-bank level 130 (e.g., a global level or a central level). This means that one instance of the error-reporting control circuit 124 and one instance of the alert circuit 126 are implemented at the global-bank level 130 can interface with two or more usage-based-disturbance circuits 120 that are implemented at the local-bank level 128. The relationship between the local-bank level 128 and the global-bank level 130 is further described with respect to FIG. 5. Other components of the memory device 108 are further described with respect to FIG. 2.

FIG. 2 illustrates an example computing system 200 that can implement aspects of controlling reporting of parity failures for usage-based-disturbance mitigation. In some implementations, the computing system 200 includes at least one memory device 108, at least one interconnect 106, and at least one processor 202. The memory device 108 can include, or be associated with, at least one memory array 204, at least one interface 206, and control circuitry 208 (or periphery circuitry) operatively coupled to the memory array 204. The memory array 204 can include an array of memory cells, including but not limited to memory cells of DRAM, SDRAM, three-dimensional (3D) stacked DRAM, DDR memory, LPDDR SDRAM, and so forth. The memory array 204 and the control circuitry 208 may be components on a single semiconductor die or on separate semiconductor dies. The memory array 204 or the control circuitry 208 may also be distributed across multiple dies. This control circuitry 208 may manage traffic on a bus that is separate from the interconnect 106.

The control circuitry 208 can include various components that the memory device 108 can use to perform various operations. These operations can include communicating with other devices, managing memory performance, performing refresh operations (e.g., self-refresh operations or auto-refresh operations), and performing memory read or write operations. In the depicted configuration, the control circuitry 208 includes the usage-based-disturbance circuit 120, the error-reporting control circuit 124 (ER control circuit 124), the alert circuit 126, at least one array control circuit 210, and at least one instance of clock circuitry 212. In some implementations, the usage-based-disturbance circuit 120, the error-reporting control circuit 124, and the alert circuit 126 are part of the control circuitry 208, as shown in FIG. 2. In other implementations, the usage-based-disturbance circuit 120, the error-reporting control circuit 124, the alert circuit 126, or some combination thereof are considered separate from the control circuitry 208.

The array control circuit 210 can include circuitry that provides command decoding, address decoding, input/output functions, amplification circuitry, power supply management, power control modes, and other functions. The clock circuitry 212 can synchronize various memory components with one or more external clock signals provided over the interconnect 106, including a command-and-address clock or a data clock. The clock circuitry 212 can also use an internal clock signal to synchronize memory components and may provide timer functionality.

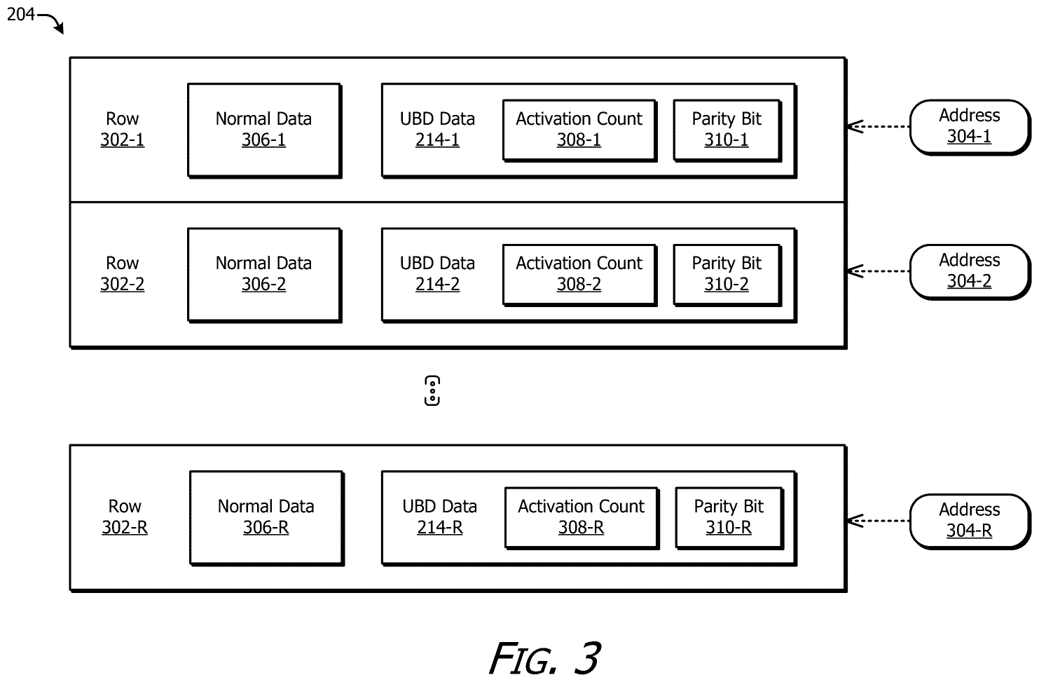

The usage-based-disturbance circuit 120 can be coupled to a set of memory cells within the memory array 204 that store usage-based-disturbance data 214 (UBD data 214). The usage-based-disturbance data 214 can include information such as an activation count, which represents a quantity of times one or more rows within the memory array 204 have been activated (or accessed) by the memory device 108. In example implementations, each row of the memory array 204 includes a subset of memory cells that stores the usage-based-disturbance data 214 associated with that row, as further described with respect to FIG. 3.

The interface 206 can couple the control circuitry 208 or the memory array 204 directly or indirectly to the interconnect 106. In some implementations, the usage-based-disturbance circuit 120,, the error-reporting control circuit 124, the alert circuit 126, the array control circuit 210, and the clock circuitry 212 can be part of a single component (e.g., the control circuitry 208). In other implementations, one or more of the usage-based-disturbance circuit 120, the error-reporting control circuit 124, the alert circuit 126, the array control circuit 210, or the clock circuitry 212 may be implemented as separate components, which can be provided on a single semiconductor die or disposed across multiple semiconductor dies. These components may individually or jointly couple to the interconnect 106 via the interface 206.

The interconnect 106 may use one or more of a variety of interconnects that communicatively couple together various components and enable commands, addresses, or other information and data to be transferred between two or more components (e.g., between the memory device 108 and the processor 202). Although the interconnect 106 is illustrated with a single line in FIG. 2, the interconnect 106 may include at least one bus, at least one switching fabric, one or more wires or traces that carry voltage or current signals, at least one switch, one or more buffers, and so forth. Further, the interconnect 106 may be separated into at least a command-and-address bus and a data bus.

In some aspects, the memory device 108 may be a “separate” component relative to the host device 104 (of FIG. 1) or any of the processors 202. The separate components can include a printed circuit board, memory card, memory stick, and memory module (e.g., a single in-line memory module (SIMM) or dual in-line memory module (DIMM)). Thus, separate physical components may be located together within the same housing of an electronic device or may be distributed over a server rack, a data center, and so forth. Alternatively, the memory device 108 may be integrated with other physical components, including the host device 104 or the processor 202, by being combined on a printed circuit board or in a single package or a system-on-chip.

As shown in FIG. 2, the processors 202 may include a computer processor 202-1, a baseband processor 202-2, and an application processor 202-3, coupled to the memory device 108 through the interconnect 106. The processors 202 may include or form a part of a central processing unit, graphics processing unit, system-on-chip, application-specific integrated circuit, or field-programmable gate array. In some cases, a single processor can comprise multiple processing resources, each dedicated to different functions (e.g., modem management, applications, graphics, central processing). In some implementations, the baseband processor 202-2 may include or be coupled to a modem (not illustrated in FIG. 2) and referred to as a modem processor. The modem or the baseband processor 202-2 may be coupled wirelessly to a network via, for example, cellular, Wi-Fi™, Bluetooth™, near field, or another technology or protocol for wireless communication.

In some implementations, the processors 202 may be connected directly to the memory device 108 (e.g., via the interconnect 106). In other implementations, one or more of the processors 202 may be indirectly connected to the memory device 108 (e.g., over a network connection or through one or more other devices). The memory array 204 is further described with respect to FIG. 3.

FIG. 3 illustrates example data stored within rows of the memory array 204. The memory array 204 includes multiple rows 302 of memory cells. For example, the memory array 204 depicted in FIG. 3 includes rows 302-1, 302-2 . . . 302-R, where R represents a positive integer. Each row 302 is associated with an address 304 (e.g., a row address, a memory row address, or a memory address). For example, the first row 302-1 has a first address 304-1, the second row 302-2 has a second address 304-2, and an R^{th} row 302-R has an R^{th} address 304-R.

Each of the rows 302 can store normal data 306 within a first subset of the memory cells associated with that row 302. The normal data 306 represents data that is read from or written to the memory device 108 during normal memory operations (e.g., during normal read or write operations). The normal data 306, for example, can include data that is transmitted by the memory controller 114 and is written to one or more rows 302 of the memory array 204.

In addition to the normal data 306, each of the rows 302 can store usage-based-disturbance data 214 within a second subset of the memory cells associated with that row 302. The usage-based-disturbance data 214 includes information that enables the usage-based-disturbance circuit 120 to mitigate usage-based disturbance. In an example implementation, the usage-based-disturbance data 214 includes an activation count 308. With the activation count 308, the memory device 108 can keep track of a quantity of accesses or activations of the corresponding memory row 302. In some example implementations, the usage-based-disturbance data 214 can also include a count of how many times a neighboring row (e.g., an adjacent or a proximate row) is refreshed in order to mitigate usage-based disturbance. Each of these counts provide an example means by which the memory device 108 can monitor for usage-based disturbance and determine when to refresh victim rows to reduce the risk of usage-based disturbance corrupting data.

In the example shown in FIG. 3, the first row 302-1 stores first normal data 306-1 within a first subset of memory cells of the first row 302-1 and stores first usage-based-disturbance data 214-1 within a second subset of memory cells of the first row 302-1. The first usage-based-disturbance data 214-1 includes a first activation count 308-1, which represents a quantity of times the first row 302-1 has been activated since a last refresh. As another example, the second row 302-2 stores second normal data 306-2 within a first subset of memory cells within the second row 302-2 and stores second usage-based-disturbance data 214-2 within a second subset of memory cells within the second row 302-2. The second usage-based-disturbance data 214-2 includes a second activation count 308-2, which represents a quantity of times the second row 302-2 has been activated since a last refresh. Additionally, the R^{th} row 302-R stores R^{th} normal data 306-R within a first subset of memory cells within the R^{th} row 302-R and stores R^{th} usage-based-disturbance data 214-R within a second subset of memory cells within the R^{th} row 302-R. The R^{th} usage-based-disturbance data 214-R includes an R^{th} activation count 308-R, which represents a quantity of times the R^{th} row 302-R has been activated since a last refresh.

The usage-based-disturbance data 214 can also include information or can be formatted (e.g., coded) in such a way as to support error detection. In this example, the usage-based-disturbance data 214 includes a parity bit 310. In particular, the usage-based-disturbance data 214-1, 214-2, and 214-R respectively includes parity bits 310-1, 310-2, and 310-R. Other implementations are also possible in which the usage-based-disturbance data 214 is coded in a manner that supports any of the error detection tests described above, such as the error-correcting-code check. Although the techniques for detecting a condition associated with usage-based disturbance is generally described with respect to the activation count 308, these techniques can generally be applied to detecting a condition based on any type of information that is represented by the usage-based-disturbance data 214, including error detection techniques.

### Example Techniques and Hardware

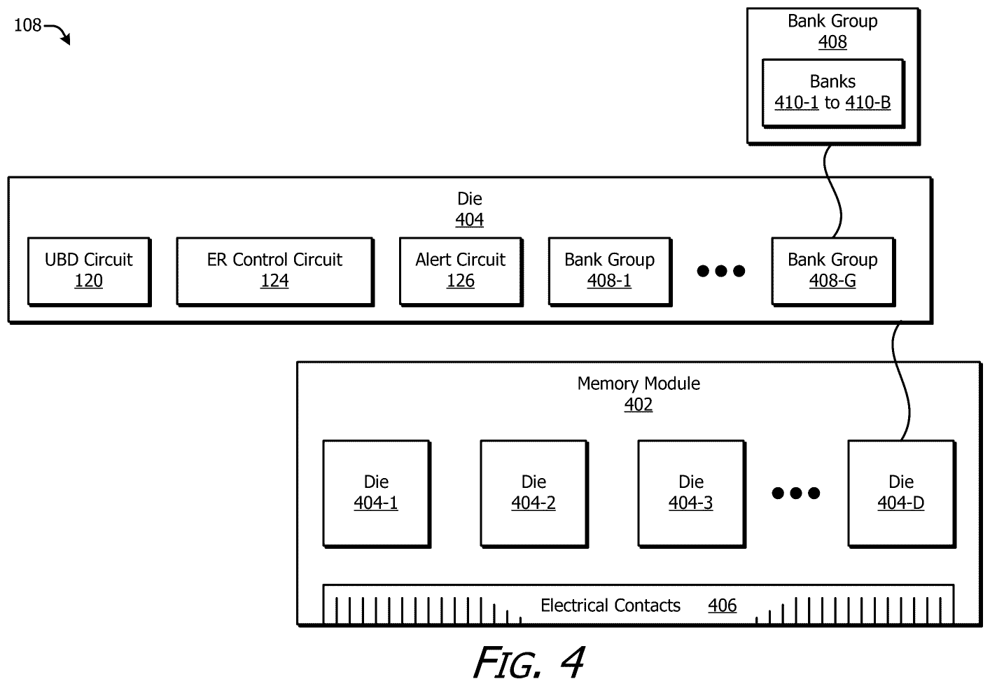

FIG. 4 illustrates an example memory device 108 in which aspects of controlling error reporting for usage-based-disturbance mitigation can be implemented. The memory device 108 includes a memory module 402, which can include multiple dies 404. As illustrated, the memory module 402 includes a first die 404-1, a second die 404-2, a third die 404-3, and a D^{th} die 404-D, with D representing a positive integer. The memory module 402 can be a SIMM or a DIMM. As another example, the memory module 402 can interface with other components via a bus interconnect (e.g., a Peripheral Component Interconnect Express (PCIe®) bus). The memory device 108 illustrated in FIGS. 1 and 2 can correspond, for example, to multiple dies (or dice) 404-1 through 404-D, or a memory module 402 with two or more dies 404. As shown, the memory module 402 can include one or more electrical contacts 406 (e.g., pins) to interface the memory module 402 to other components.

The memory module 402 can be implemented in various manners. For example, the memory module 402 may include a printed circuit board, and the multiple dies 404-1 through 404-D may be mounted or otherwise attached to the printed circuit board. The dies 404 (e.g., memory dies) may be arranged in a line or along two or more dimensions (e.g., forming a grid or array). The dies 404 may have a similar size or may have different sizes. Each die 404 may be similar to another die 404 or different in size, shape, data capacity, or control circuitries. The dies 404 may also be positioned on a single side or on multiple sides of the memory module 402.

One or more of the dies 404-1 to 404-D include the usage-based-disturbance circuit 120, the error-reporting control circuit 124 (ER control circuit 124), the alert circuit 126, and bank groups 408-1 to 408-G, with G representing a positive integer. Each bank group 408 includes at least two banks 410, such as banks 410-1 to 410-B, with B representing a positive integer. In some implementations, the die 404 includes multiple instances of the usage-based-disturbance circuit 120, which mitigate usage-based disturbance across at least one of the banks 410. For example, multiple instances of the usage-based-disturbance circuit 120 can respectively mitigate usage-based disturbance across the bank groups 408-1 to 408-G.

In other implementations, multiple instances of the usage-based-disturbance circuit 120 can respectively mitigate usage-based disturbance for respective banks 410. In this case, each usage-based-disturbance circuit 120 mitigates usage-based disturbance for a single bank 410 within one of the bank groups 408-1 to 408-B. Also, each error detection circuit 122 can control a corresponding one of the usage-based-disturbance circuit 120.

In yet other example implementations, each usage-based-disturbance circuit 120 mitigates usage-based disturbance for a subset of the banks 410 associated with one of the bank groups 408-1 to 408-G, where the subset of the banks 410 includes at least two banks 410.

Various implementations of the error-reporting control circuit 124 are also possible. In a first example, the die 404 includes a single error-reporting control circuit 124 that is coupled to the one or more instances of the usage-based-disturbance circuit 120. In a second example, the die 404 includes multiple error-reporting control circuit 124 that are coupled to respective sets of one or more usage-based-disturbance circuits 120.

The die 404 can include a single instance of the alert circuit 126, which is coupled to the one or more instances of the error-reporting control circuit 124. The relationship between the banks 410-1 to 410-B, the usage-based-disturbance circuit 120, the error-reporting control circuit 124, and the alert circuit 126 are further described with respect to FIG. 5.

FIG. 5 illustrates an example arrangement of multiple instances of the usage-based-disturbance circuit 120 on a die 404. The die 404 includes bank-specific circuitry 502 and bank-shared circuitry 504. Bank-specific circuitry 502 includes components that are associated with a particular bank 410. For example, the bank-specific circuitry 502 includes the banks 410-1, 410-2 . . . 410-(B/2), 410-(B/2+1), 410-(B/2+2) . . . 410-B and the usage-based-disturbance circuits 120-1, 120-2 . . . 120-(B/2), 120-(B/2+1), 120-(B/2+2) . . . 120-B. The usage-based-disturbance circuits 120-1 to 120-B are respectively coupled to the banks 410-1 to 410-B. In some cases, subsets of the banks 410-1 to 410-B are associated with different bank groups 408. In an example implementation, the die 404 includes 32 banks 410 (e.g., B equals 32). The 32 banks 410 form eight bank groups 408 (e.g., G equals 8), with each bank group 408 including four of the banks 410. In other cases, the banks 410-1 to 410-B are associated with a single bank group 408.

The bank-shared circuitry 504 includes components that are associated with multiple banks 410. These components perform operations associated with multiple banks 410. Example components of the bank-shared circuitry 504 include error-reporting control circuit 124 and the alert circuit 126.

On the die 404, the bank-specific circuitry 502 is positioned on two opposite sides of the bank-shared circuitry 504. Explained another way, the bank-shared circuitry 504 can be centrally positioned on the die 404. As such, the error-reporting control circuit 124 and the alert circuit 126 can be positioned closer to a center of the die 404 compared to the edges of the die 404. Positioning the bank-shared circuitry 504 in the center enables routing between the bank-shared circuitry 504 and the bank-specific circuitry 502 to be simplified.

Consider a first axis 508-1 (e.g., X axis 508-1) and a second axis 508-2 (e.g., Y axis 508-2), which is perpendicular to the first axis 508-1. In FIG. 5, the first axis 508-1 is depicted as a “horizontal” axis, and the second axis 508-2 is depicted as a “vertical” axis. Components of the bank-shared circuitry 504 are distributed across the second axis 508-2. A first set of the banks (e.g., banks 410-1 to 410-B/2) are arranged along the second axis 508-2 on a “left” side of the bank-shared circuitry 504, and a second set of the banks (e.g., banks 410-(B/2+1) to 410-B) are arranged along the second axis 508-2 on a “right” side of the bank-shared circuitry 504. The usage-based-disturbance circuits 120-1 to 120-B are positioned between the corresponding banks 410-1 to 410-B and the bank-shared circuitry 504. By positioning the error-reporting control circuit 124 and the alert circuit 126 in a central location between the usage-based-disturbance circuits 120-1 to 120-B, it can be easier to route signals between the error-reporting control circuit 124 and the usage-based-disturbance circuits 120-1 to 120-B. A relationship between the usage-based-disturbance circuit 120, the error-reporting control circuit 124, and the alert circuit 126 is further described with respect to FIG. 6.

FIG. 6 illustrates an example implementation the memory device 108, which is capable of controlling error reporting for usage-based-disturbance mitigation. Components of the memory device 108 are depicted with respect to the local-bank level 128, which is illustrated on a left side of FIG. 6, and the global-bank level 130, which is illustrated on a right side of FIG. 6. At the local-bank level 128, the memory device 108 includes the usage-based-disturbance circuit 120. At the global-bank level 130, the memory device 108 includes the error-reporting control circuit 124 and the alert circuit 126. The memory device 108 also includes at least one engine 602, at least one latch circuit 604, and at least one auxiliary memory 606, which are implemented at the global-bank level 130. The latch circuit 604 is coupled between the engine 602 and the alert circuit 126. The error-reporting control circuit 124 is coupled to the usage-based-disturbance circuit 120, the alert circuit 126, and the auxiliary memory 606.

The engine 602 can access each row of the memory array 204 in a controlled manner. The manner in which the engine 602 accesses the rows of the memory array 204 can be in accordance with an automatic mode or a manual mode. Generally, given sufficient time, the engine 602 accesses all rows of the memory array 204. In some implementations, the engine 602 accesses the rows of the memory array 204 in a periodic or cyclic manner. An order in which the engine 602 accesses the rows can be in a predetermined order, a rule-based order, or a randomized order. In some implementations, the engine 602 is implemented as a test engine, which can detect and/or correct errors within at least a subset of the data that is stored within the rows. Example engines include an error-check and scrub engine (ECS engine), an add-based engine, or a refresh engine. The engine 602 can be an existing engine within the memory device 108 that performs other functions not associated with usage-based-disturbance mitigation. In this case, the engine 602 accesses the rows 302 within the memory array 204 in a controlled manner or in a particular sequence.

The engine 602 and the latch circuit 604 enable an address 304 that is logged at the local-bank level 128 to be indirectly logged at the global-bank level 130 without having the address 304 routed directly from the local-bank level 128 to the global-bank level 130. This feature is referred to as indirect address logging. Indirect address logging utilizes the engine 602 to provide a controlled way of logging addresses 304 of rows 302 with faulty usage-based-disturbance data 214 at the global-bank level 130. It also avoids conflicts that can otherwise arise if multiple addresses 304 are logged at the local-bank level 128 across multiple banks 410 during a same time interval. With indirect address logging, the memory device 108 can provide the logged address 622 to the memory controller 114 without significantly increasing a complexity and/or cost of an interface (e.g., signal routing) between the local-bank level 128 and the global-bank level 130.

The auxiliary memory 606 represents a secondary memory that is different than the memory associated with read and write commands sent by the memory controller 114. In some implementations, the auxiliary memory 606 is a non-volatile memory, such as a fuse array, a flash memory, metal bits, a programmable read-only memory, a one-time programmable memory, and so on. Other implementations are also possible in which the auxiliary memory 606 is a volatile memory, such as a cache memory, a random-access memory, or a portion of a memory array (e.g., the memory array 204 or another memory array) that is designated for auxiliary purposes.

The auxiliary memory 606 stores one or more parameters that can be used for controlling error reporting for usage-based-disturbance mitigation. A parameter within the auxiliary memory 606 can be appropriately set (and in some cases modified) so as to adapt the error reporting for a particular design and/or architecture of the memory device 108. Example parameters can include a threshold 608 and/or a reset condition 610.

The threshold 608 defines an event that is to be reported to the host device 104. In example implementations, the threshold 608 controls the filtering of errors for reporting purposes. The threshold 608 can be appropriately set so as to account for the uncertainty regarding the level of intermittent faults and thereby enable unnecessary noise associated with these intermittent faults to be ignored (e.g., to go unreported). In some implementations, the threshold 608 can be set to a value that enables all detected errors to be reported. For instance, the threshold 608 can be set to zero.

The reset condition 610 provides overflow protection by resetting operations associated with the event detection and reporting. In some examples, the reset condition 610 represents a time limit, which can be on the order of a few hours or tens of hours (e.g., 18, 37,74, or 149 hours). Other types of conditions are also possible. In some implementations, the reset condition 610 can optionally be disabled (e.g., the time limit can be set to 0 hours).

The error-reporting control circuit 124 includes at least one event detection circuit 612 and at least one reset circuit 614. The event detection circuit 612 detects, based on the threshold 608 or based on another adjustable parameter, an occurrence of an event that is to be reported. This event can be referred to as a reporting event.

The reset circuit 614 resets the event detection circuit 612 based on the reset condition 610. In general, this resetting extends a time before the event detection circuit 612 detects another reporting event. An operation of the error-reporting control circuit 124 is further described below.

At the local-bank level 128, the usage-based-disturbance circuit 120 can detect one or more conditions (or events) that may lead to or indicate the presence of usage-based disturbance and mitigate its effects. To monitor for these conditions, the usage-based-disturbance circuit 120 maintains and updates the usage-based-disturbance data 214 that is stored in the memory array 204. If the usage-based-disturbance data 214 indicates that one of the conditions is present, then the related victim rows may be at increased risk for data corruption due to the usage-based-disturbance effect. To manage this risk, the usage-based-disturbance circuit 120 can support the refreshing of these victim rows.

In addition to detecting the presence of usage-based disturbance, the usage-based-disturbance circuit 120 also monitors for one or more errors associated with the usage-based-disturbance data 214 using the error detection circuit 122. For example, the error-detection circuit 122 can perform a parity check based on the parity bit 310.

The usage-based-disturbance circuit 120 also includes an address comparator circuit 616, which provides an indication if an address associated with a detected error is related to the row 302 that is accessed by the engine 602. The address comparator circuit 616 includes at least one comparator 618 and at least one content-addressable memory 620 (CAM 620). The content-addressable memory 620 stores one or more addresses 622 associated with faulty usage-based-disturbance data 214. In some implementations, the content-addressable memory 620 can store a single address 622 that is determined to have the faulty usage-based-disturbance data 214. In this case, the address 622 can correspond to the most recent row 302 to have been identified by the error detection circuit 122 to have failed an error detection test. This means that the address 622 stored within the content-addressable memory 620 can be overwritten if the error detection circuit 122 determines that another row 302 fails the error detection test at a later time. In other implementations, the content-addressable memory 620 can store multiple addresses 622 for multiple rows 302 that are determined to have failed the error detection test. Generally speaking, the content-addressable memory 620 logs, at the local-bank level 128, the address 622 of a row 302 that is determined to have faulty usage-based-disturbance data.

The comparator 618 enables the address 622 to be logged at the global-bank level 130 without directly sending the address 622 from the content-addressable memory 620 to the alert circuit 126. More specifically, the comparator 618 determines whether an address 304 of an activated row 302 matches a previously logged address 622. This matching enables the results of the error detection circuit 122 to be reported in a manner that is dependent on a manner in which the engine 602 accesses the rows 302, as further described below.

During operation, the usage-based-disturbance circuit 120 performs an array counter update procedure. As part of the array counter update procedure or based on the occurrence of the array counter update procedure, the usage-based-disturbance circuit 120 uses the error detection circuit 122 to test for faulty usage-based-disturbance data 214. The error detection circuit 122 performs one or more error detection tests on the usage-based-disturbance data 214 associated with the activated row 302. Additionally, the error detection circuit 122 generates an error flag 624, which indicates if an error is detected. In an example implementation, the error detection circuit 122 performs a parity check and generates a parity error flag 626 to indicate if a parity error is detected within the usage-based-disturbance data 214 of the activated row 302.

If the error flag 624 indicates an error is detected within the usage-based-disturbance data 214 of the activated row 302, the error flag 624 causes the address comparator circuit 616 to store the address 304 of the activated row 302 within the content-addressable memory 620. This stored or locally-logged address is represented by the address 622. If the error flag 624 indicates that there is no error associated with the usage-based-disturbance data 214, the error flag 624 causes the address comparator circuit 616 to take no further action (e.g., the address comparator circuit 616 does not log the address 304 of the activated row 302).

After the array counter update procedure is performed, a row 302 with address 628 is activated and the engine 602 accesses the normal data 306 stored at the address 628. In an example implementation, the engine 602 detects and/or corrects errors within the normal data 306. The latch circuit 604 latches the address 628. The comparator 618 of the address comparator circuit 616 compares the address 628 of the activated row 302 to the one or more addresses 622 stored in the content-addressable memory 620. The comparator 618 generates a match flag 630 to indicate if the addresses 628 and 622 match.

The error-reporting control circuit 124 accepts (or receives) the error flag 624 from the error detection circuit 122, the match flag 630 from the address comparator circuit 616, and a control signal 632 from the auxiliary memory 606. The control signal 632 can include the threshold 608 and/or the reset condition 610. The error-reporting control circuit 124 generates a report flag 634, which indicates if an error is to be reported.

The alert circuit 126 accepts the report flag 634 from the error-reporting control circuit 124 and the address 628 from the latch circuit 604. The alert circuit 126 can include at least one mode register 636. Using the mode register 636, the alert circuit 126 stores a value that is indicative of the report flag 634. The alert circuit 126 also stores the address 628 within the mode register 636.

The mode register 636 facilitates communication with the memory controller 114 (or one of the processors 202). Using the mode register 636, the memory device 108 can communicate information to the memory controller 114. Such communications can cause entry into or exit from a repair mode or a command that provides a memory row address to target for a repair procedure. To facilitate this communication, the mode register 636 may include one or more registers having at least one bit relating to error reporting for usage-based-disturbance mitigation. Example implementations of the error-reporting control circuit 124 and the alert circuit 126 are further described with respect to FIG. 7.

FIG. 7 illustrates example implementations of the error-reporting control circuit 124 and the alert circuit 126. In the depicted configuration, the error-reporting control circuit 124 includes the event detection circuit 612, the reset circuit 614, at least one passthrough circuit 702, at least one logic gate 704, and at least one inverter 706. The logic gate 704 is depicted as an AND gate in FIG. 7. Other types or combinations of logic gates can alternatively be used to implement the functionality provided by the logic gate 704.

The alert circuit 126 is shown to include three mode registers 636-1, 636-2, and 636-3. The mode registers 636-1, 636-2, and 636-3 respectively store values indicative of an event flag 708, the report flag 634, and the address 628. Although depicted as separate mode registers, one or more of the mode registers 636-1, 636-2, and/or 636-3 can be implemented together. In this case, the event flag 708, the report flag 634, and/or the address 628 can be associated with different operands of the mode register 636.

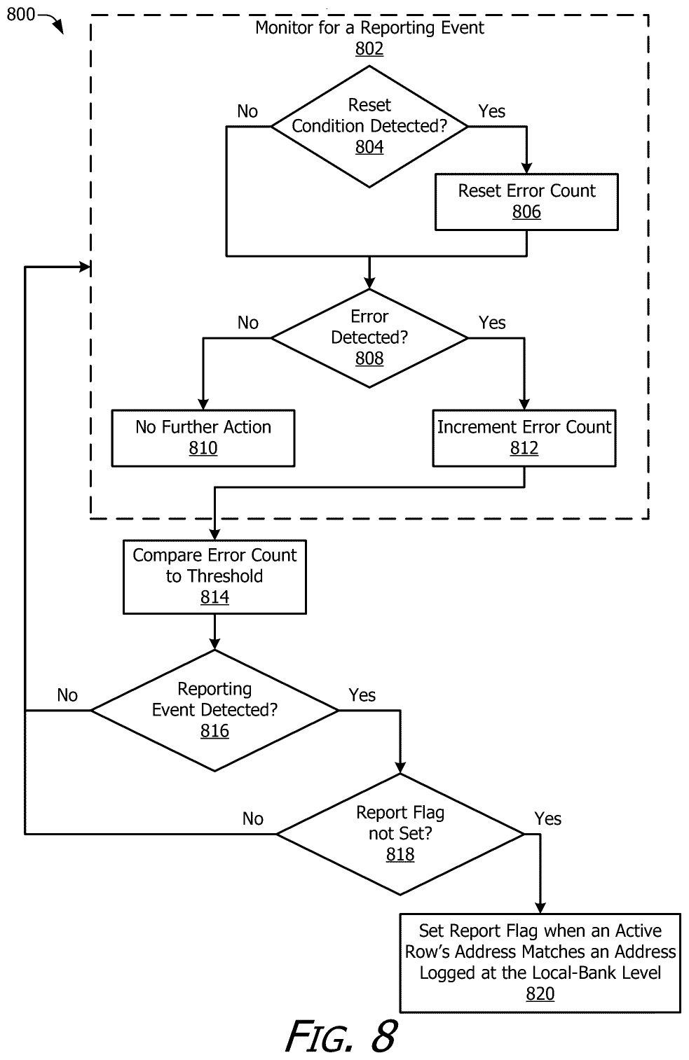

The event detection circuit 612 monitors for and detects occurrences of a reporting event. In an example implementation, the event detection circuit 612 detects an occurrence of a reporting event based on a quantity of errors that have been detected by the error detection circuit 122, as further described with respect to FIG. 8. In an example implementation, the event detection circuit 612 can include at least one counter circuit and at least one comparator.

The reset circuit 614 is coupled to the event detection circuit 612 and resets the monitoring that is performed by the event detection circuit 612 responsive to detecting an occurrence of the reset condition 610. In an example implementation, the reset circuit 614 can be implemented as an asynchronous timer. The reset circuit 614 can including a clock divider circuit for measuring an amount of time that has lapsed based on an input clock signal (not shown). An example input clock signal can be associated with a self-refresh clock.

The passthrough circuit 702 is coupled to the reset circuit 614 and the mode register 636-1. The passthrough circuit 702 enables the error-reporting control circuit 124 to generate the report flag 634 in certain situations, as further described below. The passthrough circuit 702 can be implemented using a latch or a flip-flop.

During operation, the event detection circuit 612 detects a reporting event based on the error flag 624 and the threshold 608. The event detection circuit 612 generates the event flag 708 to indicate is a reporting event is detected (e.g., to indicate a presence (or an absence) of a reporting event). The mode register 636-1 stores a value indicative of the event flag 708. The event flag 708 indicates to the host device 104 that an error associated with the usage-based-disturbance data 214 has been detected.

The reset circuit 614 generates a reset flag 712, which indicates if an occurrence of a reset condition 610 has been detected. At this time, assume that the reset circuit 614 has not detected an occurrence of the reset condition 610. For example, the reset circuit 614 determines that a timer has not expired or determines that not enough time has elapsed since a previous occurrence of the reset condition 610. In this case, the passthrough circuit 702 generates a report enable flag 710 based on the event flag 708. The report enable flag 710 enables or disables error reporting via the logic gate 704.

The logic gate 704 generates the report flag 634 based on the match flag 630 provided by the address comparator circuit 616 shown in FIG. 6, a complement of a value of the report flag 634 stored in the mode register 636-2, and the report enable flag 710 provided by the passthrough circuit 702. The report flag 634 enables the mode register 636-3 to latch the address 628. From the perspective of the host device 104, the value of the report flag 634 that is stored by the mode register 636-2 can indicate that the address 628 has been indirectly logged via the alert circuit 126 and is available at the mode register 636-3. By referencing the complement of the report flag 634 for generating the report flag 634, the error-reporting control circuit 124 also ensures that a new error is not reported until the host device 104 clears a previously reported values of the address 628, the report flag 634, and the event flag 708.

If the reset circuit 614 detects an occurrence of the reset condition 610 (e.g., determines that a sufficient amount of time has elapsed since a previous reset condition 610 occurred), the reset circuit 614 generates the reset flag 712 to cause the event detection circuit 612 to reset itself for monitoring for the reporting event. This provides overflow protection and also enables the error-reporting control circuit 124 to ignore intermittent errors. The reset flag 712 also causes the passthrough circuit 702 to generate the report enable flag 710 in a manner that disables reporting of an error. For example, the reset flag 712 causes the passthrough circuit 702 to reset the report enable flag 710 to a logic value of “0.” Example operations for monitoring for and detecting the reporting event are further described with respect to FIG. 8.

FIG. 8 illustrates an example scheme 800 performed by the error-reporting control circuit 124 for implementing aspects of controlling error reporting for usage-based-disturbance mitigation. In this example scheme 800, the reporting event occurs if a quantity of errors detected by the error detection circuit 122 satisfies the threshold 608. Also, the reset condition 610 is satisfied if an amount of time has elapsed since initialization or since a previous occurrence of the reset condition 610. The features of controlling error reporting for usage-based-disturbance mitigation can be readily adapted to other types of reporting events and/or reset conditions.

At 802, the error-reporting control circuit 124 uses the event detection circuit 612 to monitor for a reporting event. A first part of the monitoring involves determining whether the reset condition is detected, as indicated at 804. In this case, the event detection circuit 612 evaluates the reset flag 712 provided by the reset circuit 614. If the reset flag 712 indicates that a reset condition 610 is not detected (e.g., the reset flag 712 is set to a logic value of “0”), the process continues at 808. Otherwise, if the reset flag 712 indicates that a reset condition 610 is detected (e.g., the reset flag 712 is set to a logic value of “1”), then the process continues at 806. At 806, the event detection circuit 612 resets an error count, which is maintained by the event detection circuit 612. For example, the event detection circuit 612 sets the error count to a default value, which can be zero in some implementations.

At 808, the event detection circuit 612 determines if an error is detected. For example, the event detection circuit 612 evaluates the error flag 624 provided by the error detection circuit 122. If the error flag 624 indicates that an error is not detected (e.g., the error flag 624 is set to a logic value of “0”), the event detection circuit 612 takes no further action, as indicated at 810. Otherwise, if the error flag 624 indicates that an error is detected (e.g., the error flag 624 is set to a logic value of “1”), the event detection circuit 612 increments the error count at 812.

At 814, the event detection circuit 612 compares the error count to the threshold 608. At 816, the event detection circuit 612 determines if a reporting event has occurred. For example, the event detection circuit 612 does not detect a reporting event if the error count is less than the threshold 608. In this case, the process returns to 802. Alternatively, if the error count is greater than or equal to the threshold 608, the event detection circuit 612 detects an occurrence of the reporting event and the process continues to 818. At 816, the event detection circuit 612 generates the event flag 708 to indicate if the reporting event is detected. By waiting to indicate a reporting event until the quantity of errors has met the threshold 608, the event detection circuit 612 effectively filters intermittent errors and improves an accuracy of the reporting.

At 818, the error-reporting control circuit 124 determines if the report flag 634 is not set. More specifically, the error-reporting control circuit 124 determines if a value that is indicative of the report flag 634 and is stored by the mode register 636-2 indicates if the report flag 634 is previously set. In the example shown in FIG. 7, the logic gate 704 evaluates a complement of the report flag 634 stored by the mode register 636-2. If the report flag 634 is already set (e.g., was previously set and has yet to be cleared by the host device 104), the process returns to 802. Otherwise, if the report flag 634 has not been set (e.g., was not previously set), the process continues to 820.

At 820, the error-reporting control circuit 124 sets the report flag when the address 628 of an active row 302 matches an address 622 that is logged at the local-bank level 128 via the content-addressable memory 620. With respect to the example implementation shown in FIGS. 6 and 7, the error-reporting control circuit 124 sets the report flag to a logic value of “1” if the match flag 630 have a logic value of “1.” As shown in FIG. 7, the logic gate 704 sets the report flag 634 to a logic value of “1” based on the match flag 630, the complement of the report flag 634, and the report enable flag 710 also having logic values of “1.” The setting of the event flag 708 and the setting of the report flag 634 may occur at different times as the setting of the event flag 708 can occur based on the array counter update procedure while the setting of the report flag 634 can occur based on an operation of the engine 602.

### Example Methods

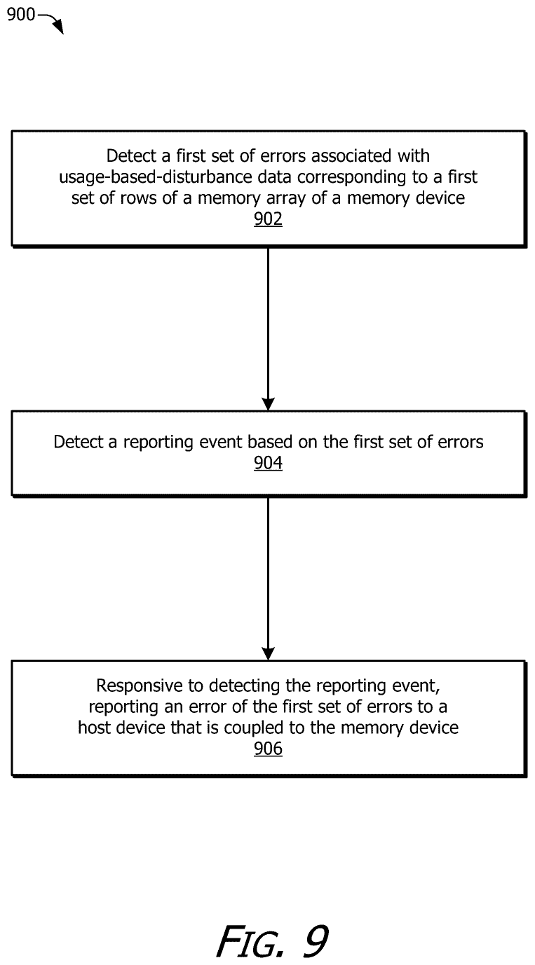

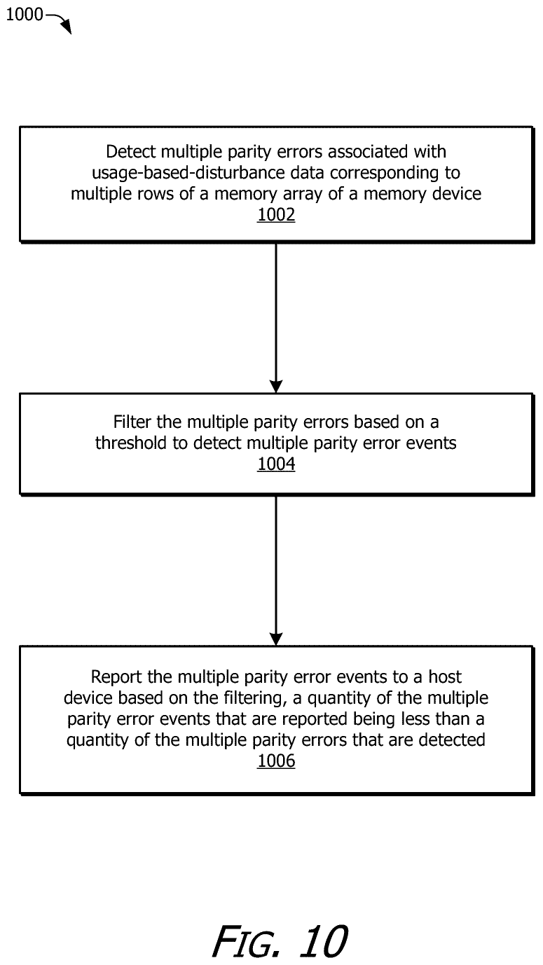

This section describes example methods for implementing aspects of controlling error reporting for usage-based-disturbance mitigation with reference to the flow diagrams of FIGS. 9 and 10. These descriptions may also refer to components, entities, and other aspects depicted in FIGS. 1 to 8 by way of example only. The described methods are not necessarily limited to performance by one entity or multiple entities operating on one device.

FIG. 9 illustrates a method 900, which includes operations 902 through 906. In aspects, operations of the method 900 are implemented by a memory device 108 as described with reference to FIG. 1. In particular, the operations of the method 900 are performed, at least in part, by the error-reporting control circuit 124 of FIG. 1.

At 902, a first set of errors associated with usage-based-disturbance data corresponding to a first set of rows of a memory array of a memory device is detected. For example, the error detection circuit 122 detects the first set of errors associated with the usage-based-disturbance data 214 corresponding to a first set of rows 302 of the memory array 204 of the memory device 108. More specifically, the error detection circuit 122 detects these errors as each row 302 within the first set of rows is activated. The errors can be associated with any type of error detection test that is performed by the error detection circuit 122. In some implementations, the error detection test is performed as part of the array counter update procedure that is performed by the usage-based-disturbance circuit 120. An example error can include a parity error.

At 904, a reporting event is detected based on the first set of errors. For example, the error-reporting control circuit 124 detects a reporting event based on the first set of errors, as indicated at 816 in FIG. 8. In an example implementation, the event detection circuit 612 detects an occurrence of a reporting event based on an error count satisfying the threshold 608. The event detection circuit 612 can set the event flag 708 to indicate if the reporting event is detected.

At 906, reporting of an error of the first set of errors to a host device that is coupled to the memory device occurs responsive to the detecting of the reporting event. For example, the error-reporting control circuit 124 generates the report flag 634 responsive to the detection of the reporting event. Other conditions can also impact the setting of the report flag 634, such as the match flag 630 and a current value of the report flag 634 that is stored in the mode register 636-2. The report flag 634 enables the address 628 to be latched and logged by the alert circuit 126. The host device 104 can reference values of the report flag 634 and the address 628 that are stored in the one or more mode registers 636. In some cases, the host device 104 initiates a repair operation based on these values. The host device 104 can also clear the values of the report flag 634 and/or the address 628 that are stored in the one or more mode registers 636.

FIG. 10 illustrates a method 1000, which includes operations 1002 through 1006. In aspects, operations of the method 1000 are implemented by a memory device 108 as described with reference to FIG. 1. In particular, the operations of the method 1000 are performed, at least in part, by the error-reporting control circuit 124 of FIG. 1.

At 1002, multiple parity errors associated with usage-based-disturbance data corresponding to multiple rows of a memory array of a memory device are detected. For example, the error detection circuit 122 detects multiple parity errors, which are associated with the usage-based-disturbance data 214 corresponding to multiple rows 302 of the memory array 204 of the memory device 108. To detect a parity error, the error detection circuit 122 determines a parity of the usage-based-disturbance data 214 corresponding to each row 302. The error detection circuit 122 compares the determined parity of the usage-based-disturbance data 214 to the parity bit 310 corresponding to the usage-based-disturbance data 214. If the parity and the parity bit 310 differ, the error detection circuit 122 detects a parity error.

At 1004, the multiple parity errors are filtered based on a threshold to detect multiple parity error events. For example, the error-reporting control circuit 124 filters the multiple parity errors based on the threshold 608 to detect multiple parity error events. The multiple parity error events represent multiple reporting events. If the threshold 608 is set to two, for instance, the error-reporting control circuit 124 can filter every other error. This means that a parity error event is detected based on an occurrence of two parity errors. The value of the threshold 608 can be appropriately set to support filtering of intermittent errors.

At 1006, the multiple parity error events are reported to a host device based on the filtering. A quantity of the multiple parity error events that are reported is less than a quantity of the multiple parity errors that are detected. For example, the error-reporting control circuit 124 reports, via the alert circuit 126, multiple parity error events to the host device 104 based on the filtering. The quantity of the multiple parity error events that are reported is less than a quantity of the multiple parity errors that are detected. Continuing with the above example in which the threshold 608 is set to two, this means that the error-reporting control circuit 124 can report every other parity error to the host device 104. In some implementations, other factors may influence whether or not the event is reported. One such factor can be based on the value of the report flag 634 stored by the mode register 636-2 (e.g., whether the host device 104 has or has not cleared the value of the report flag 634). Another factor can be the reset flag 712. If a reset condition 610 is detected prior to the reporting of the error, the reset flag 712 can disable setting of the report flag 634, as described with respect to FIG. 7.

For the figure described above, the order in which operations are shown and/or described are not intended to be construed as a limitation. Any number or combination of the described process operations can be combined or rearranged in any order to implement a given method or an alternative method. Operations may also be omitted from or added to the described methods. Further, described operations can be implemented in fully or partially overlapping manners.

Aspects of methods 900 and 1000 may be implemented in, for example, hardware (e.g., fixed-circuit circuitry or a processor in conjunction with a memory), firmware, software, or some combination thereof. The methods may be realized using one or more of the apparatuses or components shown in FIGS. 1 to 8, the components of which may be further divided, combined, rearranged, and so on. The devices and components of these figures generally represent hardware, such as electronic devices, packaged modules, IC chips, or circuits; firmware or the actions thereof; software; or a combination thereof. Thus, these figures illustrate some of the many possible systems or apparatuses capable of implementing the described methods.

Computer-readable media includes both non-transitory computer storage media and communication media including any medium that facilitates transfer of a computer program (e.g., an application) or data from one entity to another. Non-transitory computer storage media can be any available medium accessible by a computer, such as RAM, ROM, Flash, EEPROM, optical media, and magnetic media.

In the following, various examples for implementing aspects of controlling error reporting for usage-based-disturbance mitigation are described:
Example 1: A method performed by a memory device, the method comprising:
   detecting a first set of errors associated with usage-based-disturbance data corresponding to a first set of rows of a memory array of the memory device;
   detecting a reporting event based on the first set of errors; and
   responsive to detecting the reporting event, reporting an error of the first set of errors to a host device that is coupled to the memory device.
Example 2: The method of example 1 or any other example, wherein the detecting of the reporting event comprises determining a quantity of the first set of errors satisfies a threshold.
Example 3: The method of example 2 or any other example, wherein:
   a subset of the first set of errors comprises intermittent errors associated with memory cells of the memory array that store the usage-based-disturbance data; and
   a value of the threshold enables masking of at least a portion of the intermittent errors associated with the memory cells that store the usage-based-disturbance data.
Example 4: The method of example 3 or any other example, wherein the value of the threshold is greater than or equal to two.
Example 5: The method of example 4 or any other example, wherein the value of the threshold is greater than or equal to four.
Example 6: The method of example 1 or any other example, wherein the reporting of the error comprises:
   generating a report flag based on the detecting of the reporting event and based on a row of the first set of rows being activated and having an address that matches an address that is logged at a local-bank level of the memory device, the usage-based-disturbance data corresponding to the row being associated with the error;
   latching, based on the report flag, the address of the row at a global-bank level of the memory device;
   storing a value indicative of the report flag within at least one mode register of the memory device; and
   storing, based on the latching, the address of the row within the at least one mode register.
Example 7: The method of example 6 or any other example, wherein the reporting of the error comprises:
   responsive to detecting the reporting event, setting an event flag;
   storing a value indicative of the event flag within the at least one mode register of the memory device; and
   generating the report flag based on the value indicative of the event flag and based on the row being activated and having the address that matches the address that is logged at the local-bank level.
Example 8: The method of example 1 or any other example, wherein:
   the detecting of the first set of errors comprises:
      determining a parity of the usage-based-disturbance data corresponding to each row of the first set of rows;
      comparing the parity of the usage-based-disturbance data to a parity bit corresponding to the usage-based-disturbance data of each row of the first set of rows; and
      detecting a first set of parity errors associated with the usage-based-disturbance data corresponding to the first set of rows; and
   the reporting of the error comprises, responsive to detecting the reporting event, reporting a parity error of the first set of parity errors to the host device.
Example 9: The method of example 1 or any other example, further comprising:
   detecting a second set of errors associated with the usage-based-disturbance data corresponding to a second set of rows of the memory array;
   counting a quantity of the second set of errors to generate an error count;
   detecting an occurrence a reset condition; and
   responsive to detecting the reset condition, resetting the error count to a default value.
Example 10: The method of example 9 or any other example, wherein the detecting of the reset condition comprises determining that an amount of time has elapsed since a previous occurrence of the reset condition.
Example 11: A memory device comprising:
   a memory array comprising multiple rows configured to store usage-based-disturbance data;
   at least one mode register configured to:
      be coupled to a host device; and
      store a value indicative of a report flag;
   a first circuit coupled to the memory array and configured to detect a first set of errors associated with the usage-based-disturbance data corresponding to a first set of the multiple rows; and
   a second circuit coupled to the first circuit and the at least one mode register, the second circuit configured to:
      detect a reporting event based on the first set of errors; and
      set, based on the detection of the reporting event, the value indicative of the report flag and stored in the at least one mode register.
Example 12: The memory device of example 11 or any other example, wherein:
   the at least one mode register is configured to store an address of a row of the first set of the multiple rows, the usage-based-disturbance data corresponding to the row being associated with one of the first set of errors; and
   the second circuit is configured to:
      generate the report flag based on the detection of the reporting event and based on the row being activated and having the address that matches an address that is logged at a local-bank level of the memory device; and
      cause the address of the row to be latched at the at least one mode register based on the report flag.
Example 13: The memory device of example 11 or any other example, wherein the second circuit is configured to:
   generate an error count by counting a quantity of the first set of errors;
   compare the error count to a threshold; and
   detect the reporting event based on the error count satisfying the threshold.
Example 14: The memory device of example 13 or any other example, wherein the second circuit is configured to:
   monitor for a reset condition; and
   responsive to detecting the reset condition, set a value of the error count to a default value.
Example 15: The memory device of example 14 or any other example, further comprising:
   an auxiliary memory configured to:
      store a first value indicative of the threshold;
      store a second value indicative of a parameter associated with the reset condition; and
      provide the first value and the second value to the second circuit.
Example 16: The memory device of example 15 or any other example, wherein the auxiliary memory comprises at least one fuse array.
Example 17: The memory device of example 11 or any other example, wherein:
   the first circuit is implemented at a local-bank level of the memory device; and
   the second circuit is implemented at a global-bank level of the memory device.
Example 18: A method performed by a memory device, the method comprising:
   detecting multiple parity errors associated with usage-based-disturbance data corresponding to multiple rows of a memory array of the memory device;
   filtering the multiple parity errors based on a threshold to detect multiple parity error events; and
   reporting the multiple parity error events to a host device based on the filtering, a quantity of the multiple parity error events that are reported being less than a quantity of the multiple parity errors that are detected.
Example 19: The method of example 18 or any other example, wherein the reporting of the multiple parity error events comprises reporting every other parity error of the multiple parity errors.
Example 20: The method of example 18 or any other example, further comprising:
   counting the quantity of the multiple parity errors to generate an error count;
   comparing the error count to the threshold to detect the multiple parity error events; and
   resetting the error count based on an occurrence of a reset condition.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

### Conclusion

Although aspects of controlling error reporting for usage-based-disturbance mitigation have been described in language specific to certain features and/or methods, the subject of the appended claims is not necessarily limited to the specific features or methods described. Rather, the specific features and methods are disclosed as a variety of example implementations of controlling error reporting for usage-based-disturbance mitigation.

What is claimed is:

1. A method performed by a memory device, the method comprising:
detecting a first set of errors associated with usage-based-disturbance data corresponding to a first set of rows of a memory array of the memory device;
detecting a reporting event based on the first set of errors; and
responsive to detecting the reporting event, reporting an error of the first set of errors to a host device that is coupled to the memory device.

2. The method of claim 1, wherein the detecting of the reporting event comprises determining a quantity of the first set of errors satisfies a threshold.

3. The method of claim 2, wherein:
a subset of the first set of errors comprises intermittent errors associated with memory cells of the memory array that store the usage-based-disturbance data; and
a value of the threshold enables masking of at least a portion of the intermittent errors associated with the memory cells that store the usage-based-disturbance data.

4. The method of claim 3, wherein the value of the threshold is greater than or equal to two.

5. The method of claim 4, wherein the value of the threshold is greater than or equal to four.

6. The method of claim 1, wherein the reporting of the error comprises:
generating a report flag based on the detecting of the reporting event and based on a row of the first set of rows being activated and having an address that matches an address that is logged at a local-bank level of the memory device, the usage-based-disturbance data corresponding to the row being associated with the error;
latching, based on the report flag, the address of the row at a global-bank level of the memory device;
storing a value indicative of the report flag within at least one mode register of the memory device; and
storing, based on the latching, the address of the row within the at least one mode register.

7. The method of claim 6, wherein the reporting of the error comprises:
responsive to detecting the reporting event, setting an event flag;
storing a value indicative of the event flag within the at least one mode register of the memory device; and
generating the report flag based on the value indicative of the event flag and based on the row being activated and having the address that matches the address that is logged at the local-bank level.

8. The method of claim 1, wherein:
the detecting of the first set of errors comprises:
determining a parity of the usage-based-disturbance data corresponding to each row of the first set of rows;
comparing the parity of the usage-based-disturbance data to a parity bit corresponding to the usage-based-disturbance data of each row of the first set of rows; and
detecting a first set of parity errors associated with the usage-based-disturbance data corresponding to the first set of rows; and
the reporting of the error comprises, responsive to detecting the reporting event, reporting a parity error of the first set of parity errors to the host device.

9. The method of claim 1, further comprising:
detecting a second set of errors associated with the usage-based-disturbance data corresponding to a second set of rows of the memory array;
counting a quantity of the second set of errors to generate an error count;
detecting an occurrence a reset condition; and
responsive to detecting the reset condition, resetting the error count to a default value.

10. The method of claim 9, wherein the detecting of the reset condition comprises determining that an amount of time has elapsed since a previous occurrence of the reset condition.

11. A memory device comprising:
a memory array comprising multiple rows configured to store usage-based-disturbance data;
at least one mode register configured to:
be coupled to a host device; and
store a value indicative of a report flag;
a first circuit coupled to the memory array and configured to detect a first set of errors associated with the usage-based-disturbance data corresponding to a first set of the multiple rows; and
a second circuit coupled to the first circuit and the at least one mode register, the second circuit configured to:
detect a reporting event based on the first set of errors; and
set, based on the detection of the reporting event, the value indicative of the report flag and stored in the at least one mode register.

12. The memory device of claim 11, wherein:
the at least one mode register is configured to store an address of a row of the first set of the multiple rows, the usage-based-disturbance data corresponding to the row being associated with one of the first set of errors; and
the second circuit is configured to:
generate the report flag based on the detection of the reporting event and based on the row being activated and having the address that matches an address that is logged at a local-bank level of the memory device; and
cause the address of the row to be latched at the at least one mode register based on the report flag.

13. The memory device of claim 11, wherein the second circuit is configured to:
generate an error count by counting a quantity of the first set of errors;
compare the error count to a threshold; and
detect the reporting event based on the error count satisfying the threshold.

14. The memory device of claim 13, wherein the second circuit is configured to:
monitor for a reset condition; and
responsive to detecting the reset condition, set a value of the error count to a default value.

15. The memory device of claim 14, further comprising:
an auxiliary memory configured to:
store a first value indicative of the threshold;
store a second value indicative of a parameter associated with the reset condition; and
provide the first value and the second value to the second circuit.

16. The memory device of claim 15, wherein the auxiliary memory comprises at least one fuse array.

17. The memory device of claim 11, wherein:
the first circuit is implemented at a local-bank level of the memory device; and
the second circuit is implemented at a global-bank level of the memory device.

18. A method performed by a memory device, the method comprising:
detecting multiple parity errors associated with usage-based-disturbance data corresponding to multiple rows of a memory array of the memory device;
filtering the multiple parity errors based on a threshold to detect multiple parity error events; and
reporting the multiple parity error events to a host device based on the filtering, a quantity of the multiple parity error events that are reported being less than a quantity of the multiple parity errors that are detected.

19. The method of claim 18, wherein the reporting of the multiple parity error events comprises reporting every other parity error of the multiple parity errors.

20. The method of claim 18, further comprising:
counting the quantity of the multiple parity errors to generate an error count;
comparing the error count to the threshold to detect the multiple parity error events; and
resetting the error count based on an occurrence of a reset condition.
